(19) United States
(12) Patent Application Publication
(10) Pub. No.: US 2015/0039314 A1
(43) Pub. Date: Feb. 5, 2015

(54) SPEECH RECOGNITION METHOD AND APPARATUS BASED ON SOUND MAPPING

(71) Applicant: Morgan Kjølerbakken, Oslo (NO)

(72) Inventor: Morgan Kjølerbakken, Oslo (NO)

(73) Assignee: SQUAREHEAD TECHNOLOGY AS, Oslo (NO)

(21) Appl. No.: 14/366,746

(22) PCT Filed: Dec. 20, 2011
(86) PCT No.: PCT/EP2011/073364

§ 371 Date: Oct. 22, 2014

(51) Int. Cl. G10L 15/02; G06F 3/16

(52) U.S. Cl. CPC G10L 15/02; G06F 3/16; G10L 2015/025
USPC 704/254

(57) ABSTRACT

A method and system for speech recognition defined by using a microphone array that is directed to the face of a person speaking. Reading/scanning the output from the microphone array in order to determine which part of a face sound is emitting from. Using this information as input to a speech recognition system for improving speech recognition.

### INTRODUCTION

The present invention comprises a method and system for enhancing the performance of speech recognition by using a microphone array for determining which part of a face sound is emitting from by scanning the output from the microphone array and performing audio mapping.

### BACKGROUND OF THE INVENTION

In recent years speech recognition has evolved considerably and there has been a dramatic increase in the use of speech recognition technology. The technology can be found in mobile phones, car electronics and computers where it can be implemented in an operating system and in applications like for instance web browsers. A big challenge for speech recognition algorithms is interfering noise, e.g. sound sources other than sounds from the person the system is to interpret. A poor signal to noise ratio due to weak voice and/or background noise can reduce the performance of speech recognition.

Human speech comprises a structured set of continuous sounds generated in the sound production mechanism of the body. It starts with the lungs that blow out air with an Gaussian like frequency distribution that is forced up through the bronchial tract where a set of muscles named vocal chords starts vibrating. The air continues up the inner part of the mouth cavity where it follows two possible paths. The first path is over the tongue, through the teeth and mouth. The second path is through the nasal cavity and through the nose. The precise manner of how air expels distinguish sounds and classification of type of phonemes is based on this.

From where the sound actually expels depends on the sounds that are generated. For instance will the /m/ sound as in “me” be diverted through the nasal path and out through the nose, and a sound like /u/ will almost entirely be emitted through the mouth. There are also different characteristics depending on from where different sounds are emitted through the mouth. For instance the sounds /u/ and /o/ will be emitted through the mouth where the lips takes the shape of a small circle and the /i/sound will be emitted through the mouth shaped like a smile.

By using an array of microphones it is possible to map intensity as well as from where a sound is emitted from a face. When a person is sitting in front of an array it is possible to map where in a human face different sounds are emitted from. Since most of the sounds have a unique pattern it is possible to identify most of human speech by just mapping the radiation pattern of a person speaking.

Such a system will also be able to identify acoustical emotional gestures. It is for instance possible for a system to “see” that the position of emitted sounds are changing when a person shakes the head sideways when saying “no-no-no” or nod the head up and down when saying “yes”. This type of information can be used in combination with a speech recognition system or be transformed into an emotion dimension value. US-20110040155 A1 shows an example on how this can be implemented.

Electronic devices such as computers, mobiles, phones tend to comprise an increasing number of sensors for collecting different kinds of information. For instance can input from a camera be combined with audio mapping by correlating audio with video image data and algorithms for identifying faces. Identifying and tracking human body parts like the head can also be accomplished by using ultrasound. This has an advantage in low light condition compared with an ordinary camera solution.

US-7768876 B2 describes a systems using ultrasound for mapping the environment.

Other feasible solutions for detecting, identifying and tracking human body parts in low light conditions are for instance use of infrared cameras or heat detecting cameras.

Even though the latest known speech recognition systems based on interpreting sound and gestures have become quite efficient and accurate, there is a need for providing alternative methods that can be combined with known speech recognition methods and systems for enhancing speech recognition even more.

One object of the present invention is to provide a novel method and system for speech recognition based on audio mapping.

Another aspect is to use the inventive audio mapping method as input to a speech recognition system for enhancing speech recognition.

### SUMMARY OF THE INVENTION

The object of the present invention is to provide a method and system for speech recognition.

The inventive method is defined by providing a microphone array directed to the face of a person speaking, and determining which part of a face sound is emitting from by scanning the output from the microphone array and perform audio mapping.

This information can be used as supplementary input to speech recognition systems.

The invention also comprises a system for performing said method.

The main features of the invention are defined in the main claims, while further features and embodiments of the invention are defined in the dependent claims.

### DETAILED DESCRIPTION OF THE INVENTION

The invention will now be described with reference to the figures where:

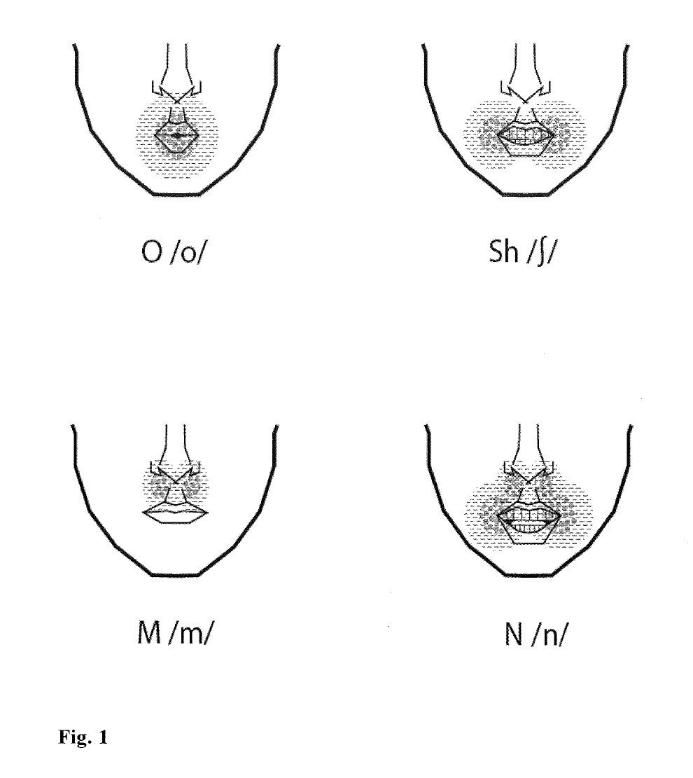

FIG. 1 shows examples of sound mappings;

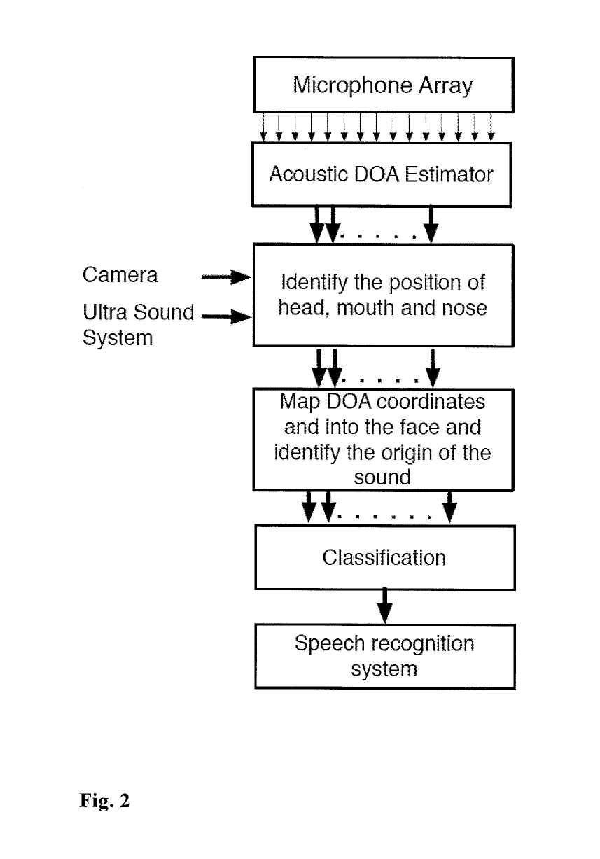

FIG. 2 shows a system overview of one embodiment of the invention, and

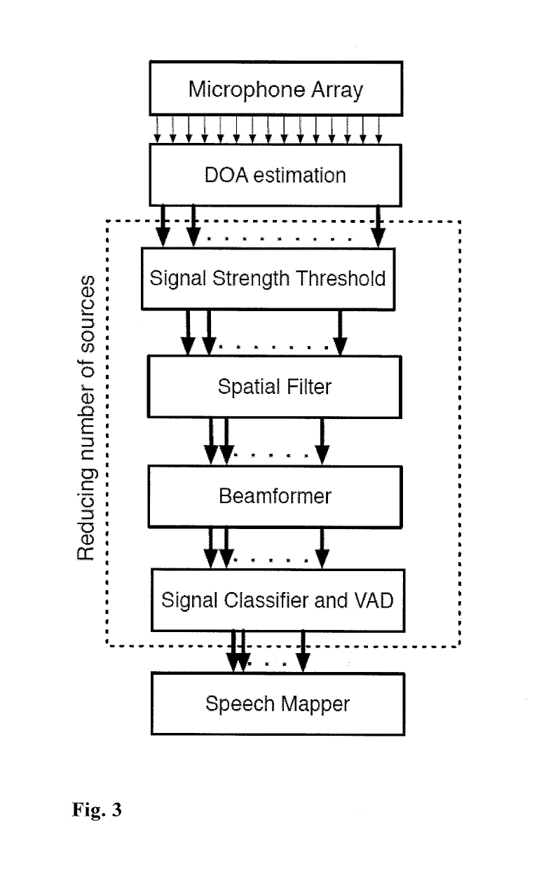

FIG. 3 shows a method for reducing the number of sources being mapped.

When a person is speaking different types of sounds are emitted. These can be classified as nasal sounds and mouth sounds or combined nasal and mouth sounds.

FIG. 1 shows examples of sounds that can be mapped to different locations in a face.

From where in the face the sound actually expels depends on sounds generated. For instance will /m/ sound as in “me” be diverted through the nasal path and out through the nose, and a sound like /u/ will almost entirely be emitted through the mouth. There are also different characteristics depending on from where different sounds are emitted through the mouth. For instance the sounds /u/ and /o/ will be emitted through a mouth where the lips takes the shape of a small circle and the /i/sound will be emitted through a mouth shaped like a smile.

In a language or dialect, a phoneme is the smallest segmental unit of sound forming meaningful contrasts between utterances.

There are six categories of consonant phonemes, i.e. stops, fricatives, affricatives, nasal, liquids, and glides. And there are three categories of vowel phonemes, i.e. short, reduced and long.

Fundamentally consonants are formed by obstructions of the vocal tract while vowels are formed by varying the shape of an open vocal tract.

More specifically said categories of consonants are: Stops where airflow is halted during the speech; Fricatives created by narrowing the vocal tract; Affricatives are complex sounds that are initially a stop but become fricatives; Nasals are similar to stops but is voiced while air expels through the nose; Liquids occurs when tongue is raised high, and Glides are consonants that either precede or follow a vowel. They are distinguished by segue from a vowel and are also known as semivowels.

The categories of vowels are: short vowels formed with the tongue placed at the top of the mouth; reduced vowels formed with the tongue in the centre of the mouth, and the long vowels formed with the tongue positioned at the bottom of the mouth.

Phonemes can be grouped into morphemes. Morphemes are a combination of phonemes that create a distinctive unit of meaning. Morphemes can then again be combined into words. The morphology principle is of fundamental interest because phonology can be traced through morphology to semantics.

Microphones are used for recording audio. There are several different types of microphones, e.g. microphone array system, analog condenser microphone, electret microphone, MEMS microphone and optical microphones.

Signals from analog microphones are normally converted into digital signals before further processing. Other microphones like MEMS and optical microphones, often referred to as digital microphones, already provide a digital signal as an output.

The bandwidth for a system for recording sound in range of human voice should at least be 200 Hz to 6000 Hz.

The requirement for distance between microphone elements in a microphone array is half the wavelength of the highest frequency (about 2.5 cm). In addition, a system will ideally have the largest aperture possible to achieve directivity in the lower frequency range. This means that ideally the array should have as many microphones as possible spaced by half the wavelength. In today's consumer electronics this is not very likely to be realized, and tracking in the higher frequency ranges is likely to be performed with an under sampled array.

The present invention is defined as a method for speech recognition where the method comprises a first step of providing a microphone array directed to the face of a person speaking, a second step of determining which part of a face sound is emitting from by scanning/sampling the output from the microphone array, and a third step performing audio mapping based on which part of a face sound is emitting from.

These steps make up the core of the inventive idea and are vital for detecting phonemes, morphemes, words and thus speech as described above.

FIG. 2 shows a system overview of one embodiment of the invention. Signals from a microphone array are input to an acoustic Direction of Arrival (DOA) estimator.

DOA is preferably used for determining which part of a face sound is emitting from. DOA denotes the direction from which usually a propagating wave arrives at a point. In the current invention DOA is an important parameter when recording sound with a microphone array.

There are a large number of possible appropriate methods for calculating DOA. Examples of DOA estimation algorithms are DAS (Delay-and-Sum), Capon/Minimum Variance (Capon/MV), Min-Norm, MUSIC (MUltiple SIgnal Classification), and ESPRIT (Estimation of Signal Parameters using Rotationally Invariant Transformations). These methods are further described and reviewed in: H. Krim and M. Viberg, “Two Decades of Array Signal Processing Research—The Parametric Approach”, IEEE Signal Processing Magazine, pp. 67-94, July 1996.

The DAS method is robust, computationally simple, and does not assume any a priori knowledge of the scenario at hand. However, its performance is usually quite limited. Capon/MVDR based methods is a statistically motivated method that offers increased performance at the cost of increased computational complexity and decreased robustness. This method does neither assume any a priori knowledge. Min-Norm, MUSIC, and ESPRIT are so-called eigenpace methods, which are high-performance, non-robust, computationally demanding methods that depend on exact knowledge of the number of sources present.

The method chosen should be based on the amount of available knowledge about the set-up, such as the number of microphones available and available processing power. For high-performance methods, certain measures can be applied to increase robustness.

The above mentioned methods can be implemented in two different ways, either as narrowband or as broadband estimators. The former estimators are computationally simple, while the latter are more demanding. To achieve good DOA estimates of human voice sources, the system should include as much of the human speech frequencies as possible. This can be achieved either by using several narrowband estimators, or a single broadband estimator. The specific estimator to use should be based on an evaluation of the amount of processing power available.

Audio mapping is used for identifying and classifying different aspects of audio recorded.

It is crucial for the audio mapper to know the position of the head and especially the mouth and nose, and map the emitting sound based on the DAO estimator to the right position. Audio mapping can be divided into different methods, e.g. methods that only relay on the data from the microphone array, and methods that also take advantage of information from other input sources like camera and/or ultrasound systems.

When performing audio mapping, based on data from the microphone array only, several parameters can be detected. The centre of audio can be detected by detecting the mouth as the centre and updating this continuously. Relative position of sound can be detected, as well as the position of where the sounds expels.

Output coordinates, from the DOA, of where sounds are expelled can be combined with information of the position of the nose and mouth, and the sounds can be mapped to determine from where the sounds are expelled, i.e. identify the origin of the sound.

Based on prior knowledge of where different phonetics sounds expels, as well as patterns of morphemes, the system is able to determine phonetics sounds and morphemes.

In one embodiment of the present invention, information of which part of a face sound is emitting from is combined with verbal input for processing in a speech recognition system for improving speech recognition. In this embodiment speech recognition will be enhanced over prior art.

Based on visual information from cameras, or a combination of cameras and/or ultrasound/infrared devices, a system can acquire information on spatial location of central parts of the human body like neck, mouth and nose.

The system can then detect and focus on the position from where sounds expels.

The coordinates of where the sounds are expelled can be combined with information from a camera and/or other sources, and the known positions of the nose and mouth, and the sounds can be mapped to determine from where the sounds are expelled.

Based on the mapping of where the sounds are expelled the systems is able to identify phonemes and morphemes.

Several different adjustments of the output signals from the microphone array can be performed before the signals are further processed.

In one aspect of the invention the mapping area of the face of a person speaking is automatically scaled and adjusted before the signals from the mapped area goes into an audio mapper.

The mapping area can be defined as a mesh, and the scale and adjustment are accomplished by re-meshing a sampling grid.

In one aspect of the invention classification of phonemes and specific phonemes is performed based on which part of a face sound is emitting from. This can be performed over time for identifying morphemes and words.

Based on prior knowledge of where different phonetics sounds expels, as well as patterns of morphemes the system is able to determine phonetics sounds and morphemes.

In one aspect of the invention filtering of signals in space is performed before signals enter the mapper.

In another aspect of the invention a voice activity detector is introduced to ensure that voice is present in the signals before the signals enter the mapper.

In yet another aspect of the invention a signal strength threshold is introduced for adapting to the surroundings before the signals enter the mapper.

Based on prior knowledge identification of acoustic emotional gestures can also be performed and used as input in a speech recognition system.

In one aspect of the invention the audio mapper is arranged to learn adaptively for improving the mapping of specific persons. Based on prior and continually updated information the system can learn exact position and size of the mouth and nose and where the sound expels when the person create phonemes and morphemes. This adaptive learning process can also be based on feedback from a speech recognition system.

Audio mapping related to specific individuals can be improved by performing an initial calibration setup by letting individuals do a dictate while performing audio mapping. This procedure will enhance the performance of the system.

Information from the audio mapper and a classifier can be used as input to an image recognition system or an ultrasound system where said systems can take advantage of said information to identify or classify objects.

In order to achieve better results in the mapper several measures can be taken.

FIG. 3 shows a method for reducing number of sources being mapped in a speech/voice mapper. The signals should be reduced and cleaned up in order to reduce the number of sources entering the mapper thereby reducing computation load.

The easiest and most obvious action would be to set a signal strength threshold for the signal level such that only signals above a certain level are relevant. This action requires almost no processing power to achieve. Another low cost action is to perform a spatial filtering so the system only detect and/or take into account signals within a certain region in space. If the system for instance knows where a persons head is prior to the signal processing, the system will only forward signals in this region. This spatial filtering can be even more effective when it is implemented directly into the DAO estimations.

A further action is to analyze the signals to make sure that only speech is passing through. This can be accomplished by first performing beamforming in the direction of the source in order to separate the source from other sources other than sounds emitted from the face of interest, and then analyze and classify this source signal by using known speech detection and/or Voice Activity Detection (VAD) algorithms for detecting if the signal recorded is speech.

In one embodiment the coordinates from DOA estimator is input to a beamformer and the output of the beamformer is input to a VAD to ensure the audio mapper is mapping speech. The output of the beamformer can at same time be used as an enhanced audio signal as input for a speech recognition system in general.

Specific realizations of DOA algorithms and Audio Mapping can be implemented in both software and hardware. A Software processes can be transformed into equivalent hardware structure, and likewise a hardware structure can be transformed into software processes.

By using detection of arrival (DOA) estimators, and correlate this with information of where different phonetics sounds expressed from a face enhance speech recognition can be achieved.

Information of which part of a face sound is emitting from can be combined with verbal and visual input from a video system for processing in a speech recognition system for improving speech recognition. Visual input can further be used for identification of acoustic emotional gestures performed.

For a fixed system where the position of the camera relative to the microphone array is known as well as type of lens used, a calibration can be performed and sound mapping can be combined with image processing algorithms that are able to recognize facial regions like nose, mouth and neck. By compiling this information the system will achieve a higher accuracy and will be able to tell from where the sound is being expelled.

The present invention is also defined by a system for speech recognition comprising a microphone array directed to the face of a person speaking, and means for determining which part of a face sound is emitting from by scanning the output from the microphone array.

The system further comprises means for combining information of which part of a face sound is emitting from with verbal input for processing in a speech recognition system for improving speech recognition.

The system further comprises means for combining verbal and visual input from a video system for processing in a speech recognition system for improving speech recognition.

To sum up the present invention, speech recognition can be improved by performing a method comprising several steps. Sounds received from several microphones comprised in a microphone array are recorded, and DOA estimators to the recorded signals are applied. The next is to map where on the human head sounds expels to determine what kind of sound or what kind of sound class the sound is. This information is then forwarded as input to a speech recognition system thereby enabling better speech recognition. Said inventive method is implemented in a system for performing speech recognition.

1. A method for speech recognition where the method is characterised in the following steps:
a) providing a microphone array directed to the face of a person speaking;
b) determining which part of a face sound is emitting from by scanning the output from the microphone array, and
c) performing audio mapping based on which part of a face sound is emitting from.

2. A method according to claim 1, characterised in that identification of classes of phonemes is performed based on said audio mapping.

3. A method according to claim 1, characterised in that identification of specific phonemes is performed based on said audio mapping.

4. A method according to claim 1, characterised in that identification of specific phonemes is performed based on said audio mapping, and where this is performed over time for identifying morphemes and words.

5. A method according to claim 1, characterised in a further step where the information from step c) is combined with verbal input for processing in a speech recognition system for improving speech recognition.

6. A method according to claim 1, characterised in a further step where the information from step c) is combined with verbal and visual input from a video system for processing in a speech recognition system for improving speech recognition.

7. A method according to claim 1, characterised in a further step where the information from step c) is combined with verbal and ultrasound/infrared input for processing in a speech recognition system for improving speech recognition.

8. A method according to claim 1, characterised in that identification of acoustic emotional gestures is performed.

9. A method according to claim 1, characterised in automatically scaling and adjusting the mapping area of the face of a person speaking before the signals goes into an audio mapper.

10. A method according to claim 9, characterised in that the mapping area is defined as a mesh, and the scale and adjustment are accomplished by re-meshing a sampling grid.

11. A method according to claim 9, characterised in that filtering of signals in space is performed before the signals enter the mapper.

12. A method according to claim 9, characterised in that a voice activity detector is introduced to ensure that voice is present in the signals before the signals enter the mapper.

13. A method according to claim 9, characterised in a signal strength threshold is introduced for adapting to the surroundings before the signals enter the mapper.

14. A method according to claim 9, characterised in that the audio mapper is arranged to learn adaptively for improving the mapping of specific persons.

15. A method according to claim 9, characterised in that audio mapping related to specific individual is improved by performing an initial calibration setup by letting individuals do a dictate while performing audio mapping.

16. A method according to claim 9, characterised in that information from the audio mapper and a classifier are used as input to an image recognition system or an ultrasound system where said systems can take advantage of said information to identify or classify objects.

17. A method according to claim 9, characterised in that coordinates from DOA estimator is input to a beamformer and the output of the beamformer is input to a VAD to ensure that the audio mapper is mapping speech.

18. A method according to claim 17, characterised in that the output of the beamformer is at the same time used as an enhanced audio signal as input for a speech recognition system.

19. A system for speech recognition, characterised in comprising
a microphone array directed to the face of a person speaking;
means for determining which part of a face sound is emitting from by scanning the output from the microphone array, and
means for performing audio mapping based on which part of a face sound is emitting from.

20. A system according to claim 19, characterised in further comprising means for combining which part of a face sound is emitting from with verbal input for processing in a speech recognition system for improving speech recognition.

21. A system according to claim 19, characterised in further comprising means for combining verbal and visual input from a video system for processing in a speech recognition system for improving speech recognition.
